(19) United States
(12) Patent Application Publication
(10) Pub. No.: US 2026/0088627 A1
(43) Pub. Date: Mar. 26, 2026

(54) Predictive Energy Management

(71) Applicant: QSecGrid, Inc., New York City, NY (US)

(72) Inventors: Gordon Winston, Katonah, NY (US); John-Philip Galinski, Forest Hills, NY (US); Nigel Walker, Ponteland (GB); Mark Thompson, Blyth (GB); Patrick J.D. Santos, Kirkland, WA (US)

(21) Appl. No.: 19/339,095

(22) Filed: Sep. 24, 2025

Related U.S. Application Data
(60) Provisional application No. 63/699,116, filed on Sep. 25, 2024.

(51) Int. Cl. H02J 3/38; G05B 13/02; H02J 3/00; H02J 13/00

(52) U.S. Cl. CPC H02J 3/38; G05B 13/027; H02J 3/004; H02J 13/10; H02J 13/13; H02J 2103/35

(57) ABSTRACT

Predictive energy management comprising systems and methods to collect information about the configuration of energy resources and historical data about energy utilization as to make recommendations on how to optimize those energy resources are disclosed. Intelligent distributed energy resources (IDERs) which are devices that are energy producers or consumers that are automatable with application programming interfaces are aggregated together. An intelligent energy profile, which comprises a summary of energy resources and historical data about utilization is generated. A predictive algorithm is applied to the intelligent energy profile thereby generating a predicted future state, and a recommendation on how to optimize against that predicted future state is generated. In some embodiments generative artificial intelligence techniques are utilized, and in some embodiments the recommendations are automatically performed via the generation of computer script embodying the recommendations. The predictive energy management techniques scale from a single building, through microgrids, to the national level.

### CROSS-REFERENCE TO RELATED APPLICATIONS

This application claims priority to a commonly owned, U.S. Provisional Patent Application No. 63/699,116, filed on Sep. 25, 2024, and titled “Predictive Energy Management,” which is herein incorporated by reference in its entirety.

### BACKGROUND OF THE INVENTION

Energy is critical for all. Energy is used for almost every activity ranging from communications, heating, transportation, and food preparation. In the case of commercial, industrial, and business operations, energy is used for production be it for manufactured goods or computer services. In short energy is at the heart of economic activity, it is critical for survival. However, for such a critical commodity, management of energy be it from the power grid to the end user is unnecessarily wasteful.

Parties and stakeholders ranging from consumers to government to utilities are interested in applying present day information technology to aging power grid infrastructure. One such effort is the transition from Distribution Network Operators (DNOs) to Distributed System Operators (DSOs). DNOs are traditional electric power grid utility operators that distribute centralized production, typically flowing unidirectionally from the central power grid to power consumers. In contrast DSOs are anticipated to take distributed generation such as home solar panels, and bidirectional transfer between microgrids which enable greater flexibility of power generation and power transfer, and therefore less waste in energy management.

To implement DSOs, technologies for virtualizing energy resources, load balancing those resources, and accounting for those resources are needed. Upon such novel deploying of such technologies, novel properties and use cases would emerge that not only provide better stewardship of energy but also give consumers more choices and options in management of energy.

### BRIEF DESCRIPTION OF DRAWINGS

The detailed description is described with reference to the accompanying figures. In the figures, the left-most digits of a reference number identify the figure in which the reference number first appears. The same reference numbers in different figures indicate similar or identical items.

FIG. 1 is a context diagram for Predictive Energy Management.

FIG. 2 is a diagram of an exemplary environment for Predictive Energy Management.

FIG. 3 is a diagram of virtualization for Predictive Energy Management.

FIG. 4 is a diagram for Intelligent Energy Profiles for Predictive Energy Management.

FIG. 5 is a flow chart for utilizing Intelligent Energy Profiles for Predictive Energy Management.

FIG. 6 is a diagram of an exemplary Energy Accounting System for Predictive Energy Management.

### DETAILED DESCRIPTION OF THE INVENTION

### Energy Orchestration as a Service: Context of Predictive Energy Management

Predictive Energy Management includes set of concepts around dynamically managing energy resources in the most efficient way. One concept is that of virtualization, where there are a set of physical energy resources that can be disaggregated into virtual resources and then reaggregated into a different set of virtual resources that optimize energy utilization for a particular location, be it residential such as private homes, commercial such as a business office or retail establishment or cinema, industrial such as a factory, or governmental/public such as schools or hospitals.

Concomitant with virtualization is a related concept around an adaptability infrastructure for physical energy resources. The idea is that allocation of an energy resource should not be limited to its physical attributes including capacity and location. Physical energy resources can include any producer (e.g., generator) or consumer (e.g., heat pump) of energy. These include without limitation batteries, thermostats, heat pumps, electric vehicle (EV) chargers, solar panels, wind turbines, and inverters. Consider where an individual home with its own meter has solar panels. If the individual home had excess electricity, it should be able to share the excess with other consumers that had need regardless that the solar panels were on someone else's house. However, this notion of sharing can be taken further.

Conversely consider a locality with a set of homes, each home with its own physical battery or batteries. Each battery could be disaggregated, that is have its energy storage capacity subdivided, and each subdivision allocated to a different consumer, regardless of location. For each consumer, the different subdivisions accessed could be combined together from a software perspective, i.e., for reporting, control, and management, and once combined could appear as a single battery. This process is known as reaggregation into a virtual energy resource, in this case a virtual battery.

Enabling disaggregation and reaggregation of physical energy resources into virtual energy resources frees energy resources to be allocated in an optimal configuration rather than being limited by physicality and locality. With energy resources available for virtualization, the following example scenarios are available. In a first exemplary scenario, a virtual battery with 10 GWh storage aggregated from remote batteries could be allocated just in time for a short period for a site in a locality where a storm is expected. In a second exemplary scenario, a virtual battery with 10 GWh storage capacity could be deployed for a set of homes for grid balancing, that is removing energy consumption spikes and troughs.

For purposes of terminology, when physical energy resources can be mixed and matched independent of location on the power grid, these resources are known as Distributed Energy Resources or DERs. Note that DERs can support and expose remote automation and network capabilities to enable remote control and monitoring (telemetry, historical data, and configuration data) via software application programming interfaces (APIs). When such APIs are available, the distributed energy resources are known as Integrated DERs or IDERs. In some cases, physical energy resources might not be allocated to the power grid at large, but also not necessarily allocated to a single energy meter, but rather to a single geographic location. Examples include campuses, schools, factories, and apartment buildings. Such collections of physical energy resources that are controlled, monitored, and managed as a single entity are called microgrids.

Note that there are different ways to expose remote automation and network capabilities. For some devices, such as an inverter or heat pump, the device itself may simply have an API. However, in other cases, such as arrays of solar panels and arrays of batteries, remote automation and control capabilities are not on each and every device but may be aggregated and controlled through a single management system. For purposes of this application, the term IDER is intended to also include any DER that is automated indirectly through a management system or other software, and any DER that is aggregated and jointly managed through a management system or other software.

The concept of virtualization is based on disaggregation and reaggregation through software. The notion is that through software, energy resources can be deployed upon need, sometimes referred to as “just in time” deployment, according to some objective function (an objective function is a mathematical function to optimize to) such as functions to optimize for cost, to optimize for energy availability (consider rolling blackouts where the least number of people are affected, or high critical consumers such as hospitals are prioritized), or to optimize for least energy transfer latency (consider making a virtual battery resource available two hours in advance of a storm as opposed to two days). This deployment and redeployment according to some selected optimization principle is called Energy Orchestration. Where the software service implementing Energy Orchestration is via a subscription service, generally available from the cloud, the service is known as Energy Orchestration as a Service or (EOaaS). In this scheme, energy consumers can be understood to mediate energy consumption and generation via a virtual power plant comprised of a dynamically changing set of virtual energy resources.

Energy Orchestration therefore can be understood as just in time deployment and redeployment of virtual energy resources. Accordingly, just in time deployment relies on accurate predictions of generation and consumption. Predictions are implemented via statistical operation on telemetry of the various energy resources and usage patterns of consumers. Predictions may be performed via various statistical algorithms. Per recent developments, algorithms used may additionally or alternatively include machine learning (ML) algorithms and/or generative AI (GenAI) approaches. Accordingly, Energy Orchestration that makes use of analytics to generate accurate predictions is called Predictive Energy Management. Collections of data that characterize customer usage as to support Predictive Energy Management are called Intelligent Energy Profiles.

IDERs which have software APIs can be connected to an energy management aggregation service. However, different IDERs, such as from different vendors, may have different APIs. As Energy Orchestration relies on accurate predictions, not only should the APIs be made compatible with each other, the APIs should provide the necessary telemetry to implement accurate predictions of energy consumption, generation, and other events such as downtime. This concept of adding software layers, called drivers, to make disparate IDERs appear consistent for purposes of Energy Orchestration and providing the telemetry supportive of Predictive Energy Management is called Adaptive Resource Interfacing.

As previously mentioned, Energy Orchestration optimizes according to an objective function. However, an objective function will rely on data that is aggregated and rolled up consistently. To this end, techniques to implement an Energy Accounting System are disclosed. Specifically, consumption and generation data is aggregated according to a Chart of Accounts, and accounting principles and techniques can be brought to bear to account for consumption (debits) and generation (credits). Using accounting principles, a reporting system can provide reliable and consistent reports and recommendations.

As a final point, Predictive Energy Management relies on the collection of consumer data. However, Intelligent Energy Profiles can contain sensitive consumer information. Such data is properly subject to privacy and cybersecurity regulation. One key principle of the disclosed subject matter is that sensitive data is to be encrypted, and where a consumer requests, that sensitive data is to be timely deleted. However, when data that was relied upon for accurate predictions is deleted, other sources of information should be brought to bear, or otherwise predictions should fail gracefully, i.e., allowances for less accurate predictions should be made by the software infrastructure until the variances are no longer acceptable.

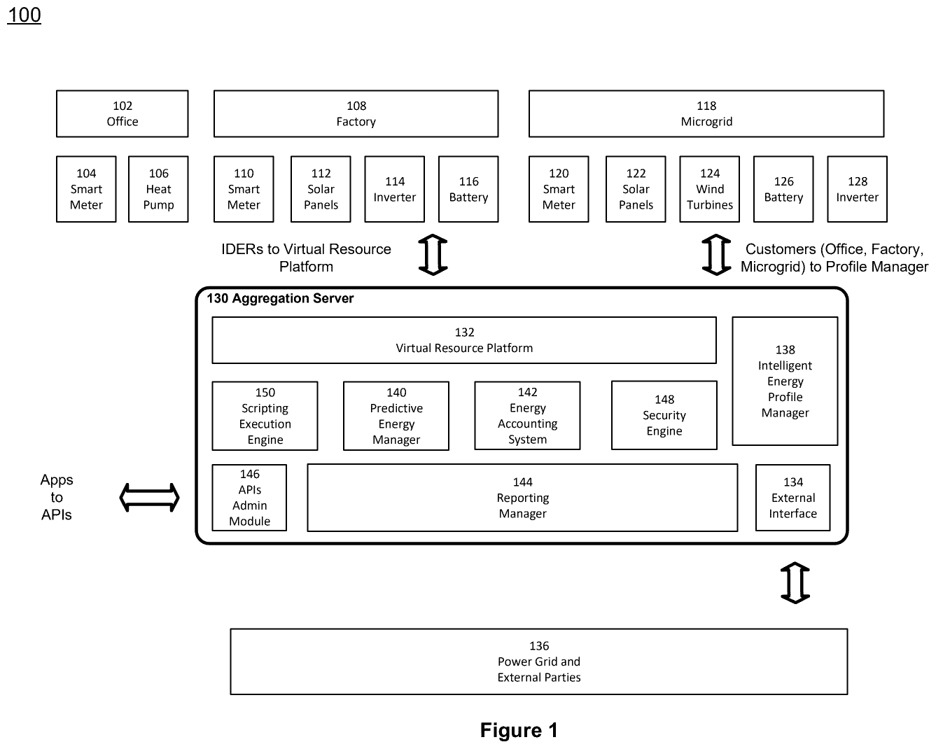

FIG. 1 is a context diagram 100 for Energy Orchestration including Predictive Energy Management and Intelligent Energy Profiles. One or more power utilities may serve a locality with an industrial campus that includes an office 102 with meter 104 heat pump 106 for an IDER. The industrial campus may also have a factory 108 with meter 110, solar panels 112, inverter 114, and battery 116 as IDERs. Note that a factory 108 in practice may have multiple meters. The industrial campus may also have a microgrid 118 with meter 120, solar panels 122, wind turbines 124, battery 126, and inverter 128 as IDERs.

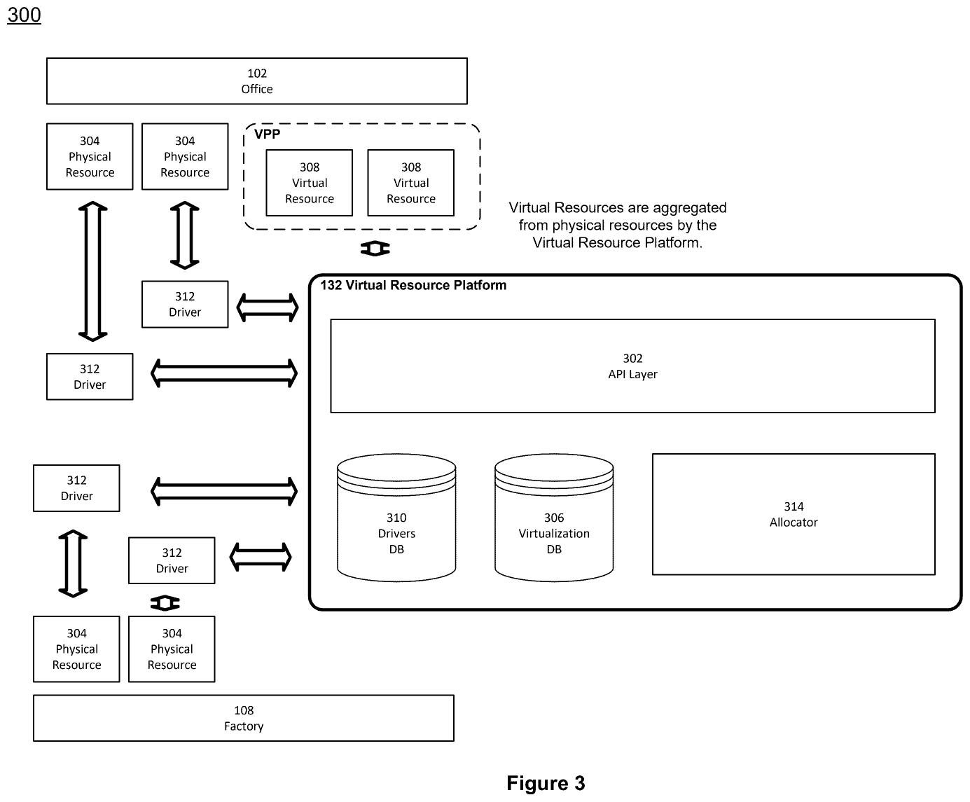

Energy Orchestration involves the disaggregation of the IDERs and reaggregation into virtual energy resources. This is effected via an Aggregation Server 130. Note that office 102 is strictly a consumer of energy with its heat pump 104. To achieve disaggregation, Aggregation Server 130 interfaces with all the IDERs via a software Virtual Resource Platform 132. Each of the IDERS may interface with a software driver that provides a consistent API supportive of Predictive Energy Management. The software driver is described in more detail with respect to FIG. 3 below. The Aggregation Server 130 has an External Interface 134 to enable information exchange and power exchange with the power grid 136 at large (such as energy suppliers and DNOs) and access to third-party information such as from other utilities (e.g., utilization data, tariff data), third-party billing systems, and third-party carbon data.

Note that in this scheme, office 102 and factory 108 are operating from their respective virtual power plants comprised of virtual energy resources served by the aggregation server 130. Indeed, the virtual energy resources are reaggregated from the physical energy resources. To achieve the reaggregation in providing virtual resources, office 102 and factory 108 may make requests of the Aggregation Server 130 for virtual resources. Alternatively, the Aggregation Server 130 may predict requirements and if so configured, may dynamically create and allocate a virtual resource. This is achieved via a software Intelligent Energy Profile Manager (Profile Manager for short) 138 that tracks both usage configuration, energy historical data, and potentially third party information such as market and environmental data sometimes summarized into a statistical summary called an Intelligent Energy Profile, which is then analyzed by a software Predictive Energy Manager 140 to predict resource needs for the consumers, here the office 102 and factory 108. The Predictive Energy Manager 140 acts as a forecasting engine for the Aggregation Server 130. Specifically, the Predictive Energy Manager 140 makes use of analytics algorithms, including machine learning and/or Generative AI algorithms, to predictively determine one or more virtual energy resources to serve, and upon such determination accesses the Virtual Resource Platform 132 to redirect resources and update the Intelligent Energy Profile Manager 138, the Virtual Resource Platform 132 itself, and a software Energy Accounting System 142 as to what virtual resource the redirected resources are now allocated to.

The Energy Accounting System 142, tracks aggregations, disaggregations, events, and associates these not only with a user profile as managed by the Intelligent Energy Profile Manager 138, but also according to an accounting chart of accounts. A software Reporting Manager 144 provides an interface for external parties to query the Energy Accounting System 142 and the Aggregation Server 130 at large. Users of the Reporting Manager 144 include mobile applications for users, and an energy portal web site.

A privileged set of users are administrators for the aggregation server 130. A software Administrative Module 146 serves an administrative portal to enable diagnostics, monitoring, and maintenance of the virtual resources and operation of the Aggregation Server 130.

The concepts around virtualization, disaggregation, and reaggregation as well as Adaptive Resource Interfacing are described in further detail with respect to FIG. 3 below.

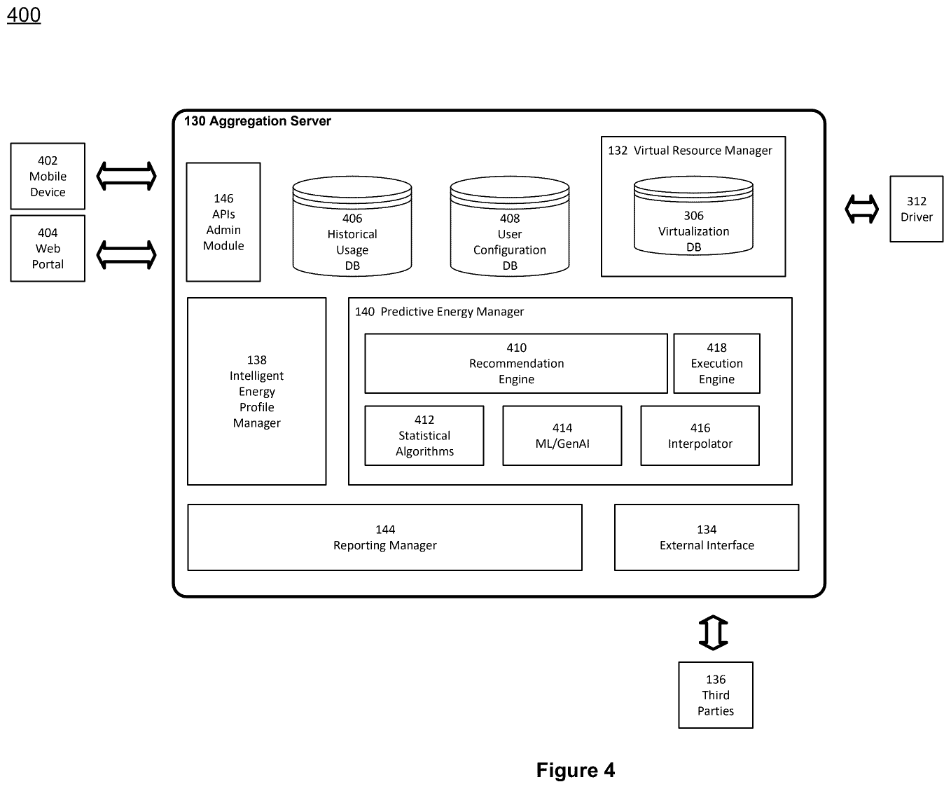

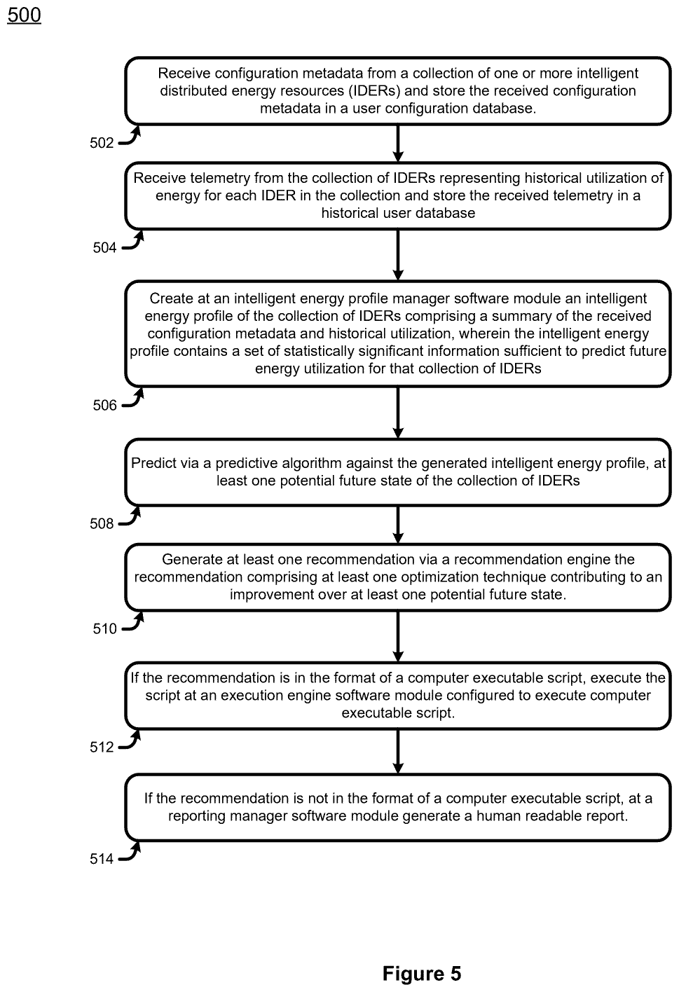

The concepts around Intelligent Energy Profiles and Predictive Energy Management are described in further detail with respect to FIGS. 4 and 5 below.

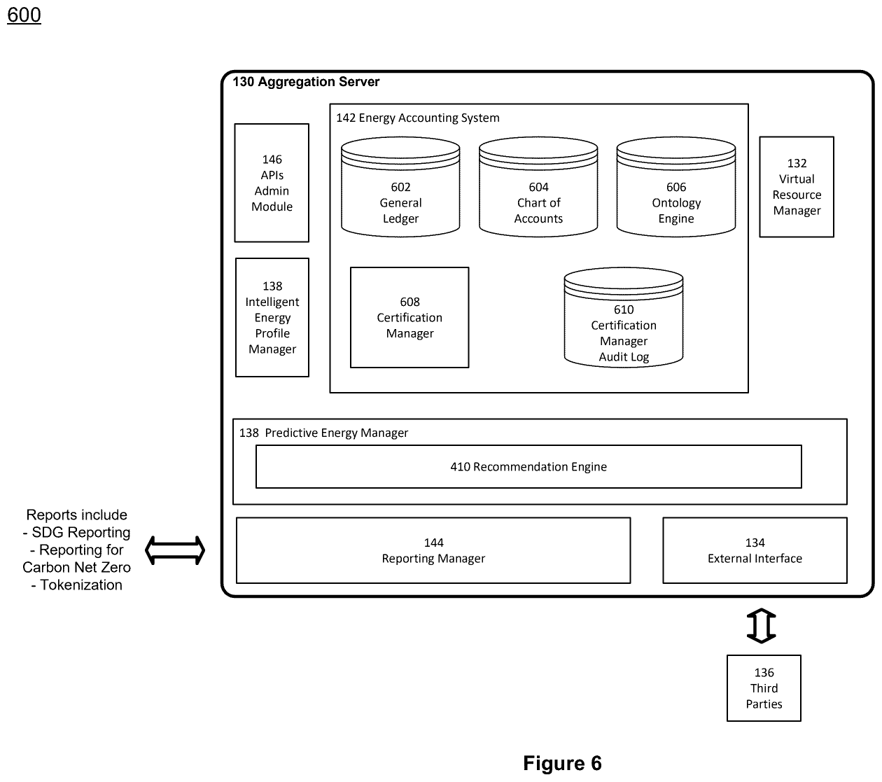

The concepts around an energy accounting system are described in further detail with respect to FIG. 6 below.

As mentioned above, users have the right to have data associated with their accounts deleted. Upon deletion of user data, often at user request, the predictive capabilities of the Aggregation Server 130 should fail gracefully. The logic to support this is provided via a software Security Engine 148. The operation of the Security Engine 148 is described in further detail below.

The Aggregation Server 130 also provides a platform not just for reports but also for applications. To this end, a software Script Execution Engine 150 is included with the Aggregation Server 130 to run applications as embodied as scripts. Exemplary Business applications and the operation of the Script Execution Engine 150 is described in further detail below.

### Exemplary Environment for Predictive Energy Management

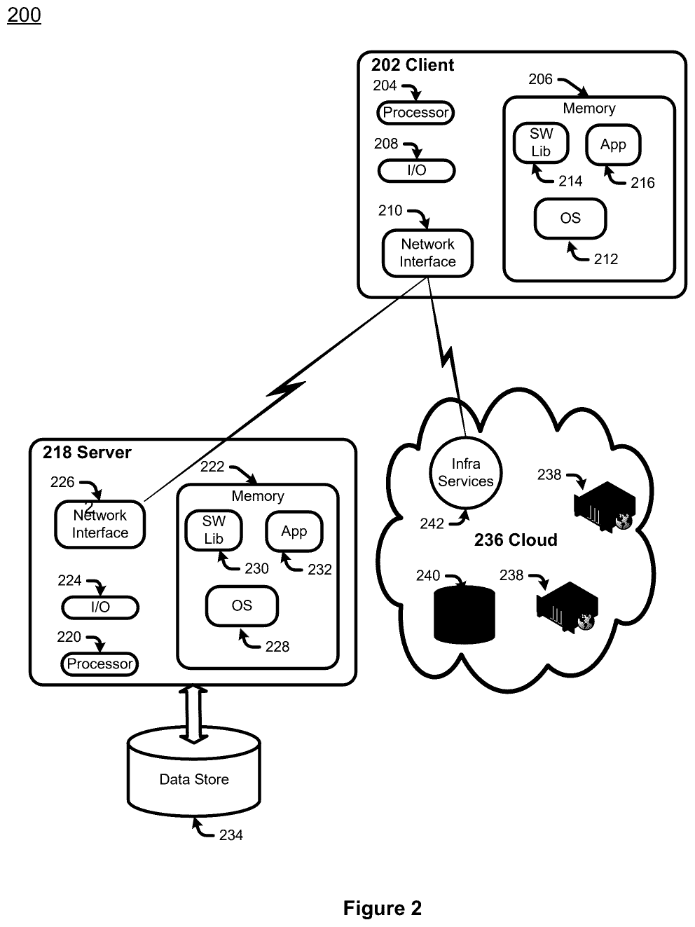

Before describing Predictive Energy Management in more detail, we describe in FIG. 2 an environment diagram 200 of an exemplary hardware, software, and communications computing environment.

### Client Platforms

The functionality for Predictive Energy Management is generally hosted on a computing device. Exemplary computing devices include without limitation personal computers, laptops, embedded devices, tablet computers, smart phones, and virtual machines. In many cases, computing devices are to be networked.

One computing device may be a client computing device 202. The client computing device 202 may have a processor 204 and a memory 206. The processor may be a central processing unit, a repurposed graphical processing unit, and/or a dedicated controller such as a microcontroller. The client computing device 202 may further include an input/output (I/O) interface 208, and/or a network interface 210. The I/O interface 208 may be any controller card, such as a universal asynchronous receiver/transmitter (UART) used in conjunction with a standard I/O interface protocol such as RS-232 and/or Universal Serial Bus (USB). The network interface 210 may potentially work in concert with the I/O interface 208 and may be a network interface card supporting Ethernet and/or Wi-Fi and/or any number of other physical and/or datalink protocols.

Memory 206 is any computer-readable media which may store software components including an operating system 212, software libraries 214, and/or software applications 216. In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes at least two types of computer-readable media, namely computer storage media and communications media. Computer storage media includes volatile and non-volatile, removable, and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD), Blu-Ray™ or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

### Server Platforms

A server 218 is any computing device that may participate in a network. The network may be, without limitation, a local area network (“LAN”), a virtual private network (“VPN”), a cellular network, or the Internet. The server 218 is similar to the host computer for the image capture function. Specifically, it will include a processor 220, a memory 222, an input/output interface 224, and/or a network interface 228. In the memory will be an operating system 228, software libraries 230, and server-side applications 232. Server-side applications include file servers and databases including relational databases. Accordingly, server 218 may have a data store 234 comprising one or more hard drives or other persistent storage devices.

One particular type of server 218 is an edge computing server. Edge computing servers provide geographically proximate computing services near end users to reduce network latency. Edge computing servers are often used in the context of telecommunications and optimizing mobile applications. In one embodiment, predictive models for ML and GenAI may be placed on such edge servers. Specifically, much historical data is geographically specific, and Machine Learning (ML) models including reward models for Generative AI (ML models to bias Large Language Models to a particular application) may be hosted on such edge servers based on locality.

### Cloud Service Platforms

A service on cloud 236 may provide the services of a server 218. In general, servers may either be a physical dedicated server or may be embodied in a virtual machine. In the latter case, cloud 236 may represent a plurality of disaggregated servers which provide virtual application server 238 functionality and virtual storage/database 240 functionality. The disaggregated servers are physical computer servers, which may have a processor, a memory, an I/O interface and/or a network interface. The features and variations of the processor, the memory, the I/O interface and the network interface are substantially similar to those described for server 218. Differences may be where the disaggregated servers are optimized for throughput and/or for disaggregation.

Cloud 236 services 238 and 240 may be made accessible via an integrated cloud infrastructure 242. Cloud infrastructure 242 not only provides access to cloud services 238 and 240 but also to billing services and other monetization services. Cloud infrastructure 242 may provide additional service abstractions such as Platform as a Service (“PAAS”), Infrastructure as a Service (“IAAS”), and Software as a Service (“SAAS”).

As stated above, cloud 236 services generally disaggregate physical servers and reaggregate them into virtual machines. This process is accomplished via a software component called a hypervisor. Virtual machines appear to be like a physical server, but because of the disaggregation and reaggregation process, hypervisors enable the efficient use of hardware, as the virtual machine includes only the compute, store, and automation hardware requested, leaving excess hardware capacity to be used in other virtual machines.

Because virtual machines behave like physical servers, the time to boot up the virtual machine may take an unacceptable amount of time. To this end, containerization software such as Google Kubernetes™ and Docker, enable partitions of the virtual machine (called containers), to perform compute functions on demand without boot time delay.

### Virtualization and Adaptive Resource Interfacing for Predictive Energy Management

Recall that Energy Orchestration relies on disaggregation of physical energy resources and the reaggregation of portions of those physical energy resources into virtual energy resources. This process is known as virtualization. Virtualization is accomplished in the aggregation server 130 via the virtual resource platform 132. FIG. 3 is a diagram 300 illustrating virtualization.

The Aggregation Server 130 is communicatively coupled to different customers, such as an office 102 or factory 108 or with a microgrid 118. The Aggregation Server 130 is also connected with the power grid at large via External Interface 134. Each customer 102, 108 has its own physical energy resources usually in the form of an IDER 304 and has its own virtual power plant comprised of a plurality of virtual energy resources 306.

The Aggregation Server 130 will either receive a request from a consumer, potentially from a mobile application or web portal via aggregation server APIs 146 for a change in energy resources or will via analytics in the Predictive Energy Manager 140 determine the need for a change in energy resources. That change in energy resources may be the deallocation of a virtual energy resource, the allocation of a virtual energy resource, or a change in the composition of a virtual energy resource. Those changes are sent to the Virtual Resource Platform 132 for implementation.

Virtual Resource Platform 132 The API Layer 302 provides a software programmatic interface for the Virtual Resource Platform 132 overall. It is accessible via various programming language bindings such as via C/C++, Java, GoLang and other common programming languages. In some embodiments it may be exposed via cloud APIs where it may be scripted with scripting languages such as Python, JavaScript, and Typescript. The API Layer 302 provides access to operations to create, delete, and update virtual energy resources, reporting, diagnostics, and other administrative functions. Accordingly, the Virtual Resource Platform 132 will receive a request for a change from the Predictive Energy Manager 140 via API Layer 302.

Adaptive Interfacing of IDERs is managed via a Drivers Database 310. The Drivers Database 310 tracks the identity of specific physical energy resources to energy resource types and drivers. Accordingly, if the request to add a new IDER as a physical resource, the Virtual Resource Platform 132 identifies the energy resource type of the physical energy resource by function. Examples of energy resource types include without limitation smart meters, inverters, solar panels, wind turbines, heat pumps, and thermostats. The determination of energy resource type is accomplished via a lookup table in a Drivers Database 310 that maps make and model and other physical energy resource identifiers to energy resource type. Upon identification of the energy resource type, the Drivers Database 310 looks for the location of a software driver 312 corresponds to the IDER.

The Virtualization Database 306 tracks the physical energy resources and virtual energy resources associated with specific users. New physical resources are registered by adding records identifying a physical energy resource, its attributes, and the consumer the physical energy resource belongs to. Allocations are made via creating a record of a virtual energy resource, and allocating portions of physical energy resources to that virtual energy resource, and then serving the virtual energy resource to the requesting party, usually the Predictive Energy Manager 140. Deletion of a physical energy resource generally involves the deallocation of any virtual energy resources reliant on the physical energy resource, and then deleting the registration records of the physical energy resource. Where history audit capability is to be retained, instead of the deleting records, the Virtualization Database 306 may instead mark records as inactive along with a date-time stamp of the time when active.

Accordingly, if a received request is to add a new physical energy resource, the Virtual Resource Platform 132 registers the IDER and driver by associating it with the consumer owning the IDER in the Virtualization Database 306. Similarly, if the received request is to delete a physical energy resource, the Virtual Resource Platform 132 deallocates any related virtual energy resources reliant on the physical energy resources and then either deletes or marks as inactive the records in the Virtualization Database 306.

Once physical energy resources are registered with the Virtualization Database 306 those resources may then be subdivided, and reaggregated into virtual resources. This is accomplished via a software energy resource Allocator 308. The Allocator 308 creates, deletes, and updates records in the Virtualization Database 306 identifying the specific subdivisions of disaggregated physical energy resources, identifying a virtual energy resource comprised of a master record for the virtual energy resource and detail records of the subdivisions constituting a reaggregation, and the identity of the consumer (or virtual power plant) the virtual energy resource is allocated to. In the case of virtual power plants, the Virtualization Database 306 may store a master record for a consumer associating it with a record for a virtual power plant, which in turn stores detail records of virtual energy resources. Alternatively, the Virtualization Database 306 may delegate to a third-party database the task of tracking virtual power plants, such as one managed by a utility.

Accordingly, where a virtual energy resource is to be allocated, the Allocator 314 receives from the API Layer 302 a request comprised of a consumer and a quantity of virtual resources to be served. Physical energy resources that are not yet allocated are identified via a best fit algorithm, and then aggregated into one or more virtual energy resources based on energy resource type. Note that the Virtualization Database 306 stores what subdivisions of physical energy resources are already allocated or otherwise in use. The Allocator 314 then stores in the Virtualization Database 306 a master record with the new virtual energy resource, detail records of the constituent portions of the physical energy resources, and a record associating the virtual energy resource with a consumer and/or consumer virtual power plant.

Deallocation of a virtual resource is the same process in reverse. Upon receiving a request from the API Layer 302 to deallocate a virtual energy resource, the Allocator 314 will update the Virtualization Database 306 by disassociating the virtual energy resource from the consumer and/or consumer virtual power plant, deleting or deactivating detail records of physical energy resource subdivisions, and deleting or deactivating the record of the virtual energy resource itself. Because the physical energy resource subdivisions are no longer associated with a virtual energy resource, the Virtualization Database 306 will indicate those physical energy resource subdivisions as available for reallocation.

Recall that the drivers 312 that interface with IDERs 304 support a standard API on a per energy resource type basis. Specifically, batteries have a standard API for the Virtual Resource Platform 132 to invoke, as do smart meters, heat pumps, solar panels, or any other consumer or generator of energy. Recall that because the physical energy resources are IDERs, they have APIs but, because they have different makes and models the APIs will vary widely. The standard API is therefore implemented in terms of the particular make and model of the physical energy resource. In this way the Virtual Resource Platform 132 is able to handle the different resource makes and models.

Note that the drivers 312 do not merely provide a consistent API interface for the Virtual Resource Platform 132, but also to the Predictive Energy Manager 140 and to the Aggregation Server 130 itself. The standard API used for each energy resource type contains APIs to retrieve usage telemetry sufficient to support the predictive statistics of the Predictive Energy Manager 140. This includes energy transfer over time, downtime, and failure events. In some cases, it is understood that some makes and models do not provide an API that supports predictive statistics. In this case, the driver may report a “not-implemented” error when the specific API is invoked. In this case, the Predictive Energy Manager 140 can make use of heuristics to estimate the missing statistics. An example is to make use of third-party benchmarks or perform statistical averaging over historical use of the physical energy resource or other resources of the same make and resource type. Alternatively, the driver may implement these gap filling heuristics itself.

### Intelligent Energy Profiles for Predictive Energy Management

An emergent property of virtualization and Energy Orchestration is Predictive Energy Management. Presently, consumers might be able to get reporting on individual IDERs associated with their bill and might be able to optimize individual IDERs. However, Energy Orchestration and virtualization provide visibility not only to one's virtual power plant, but also to all virtual resources available on the Aggregation Server 130, and the ability to perform optimizations not just across IDERs in one's virtual power plant, but also optimizations between different consumers. Consider the example of two schools next to each other. The two schools would not only be able to optimize their own resources but also trade and load balance. Note further that because the power plants are virtualized, there is no need for the schools to be geographically proximate. A school in London could load balance with another school in Newcastle provided that their infrastructure was virtualized and they participated on the same power grid.

The ability to collect information not just for one's virtual power plant but also to get information as to options to optimize one's energy usage holistically is called Predictive Energy Management. The collection of the aforementioned information to enable Predictive Energy Management is called an Intelligent Energy Profile. FIG. 4 is a diagram 400 illustrating Intelligent Energy Profiles and Predictive Energy Management.

A consumer may make use of a mobile device 402 and/or a web portal 404 to access the Aggregation Server 130. The Mobile Device 402 may have a mobile app or may simply provide a browser to access web portal 404. Regardless, the client software accesses the Aggregation Server 130 via Aggregation Server APIs 146.

The Aggregation Server 130 will have a software Intelligent Energy Profile Manager (or Profile Manager for short) 138 which will have access to Historical Usage Database 406 and User Configuration Database 408. The Historical Usage Database 406 provides historical data of the consumer's energy generation and energy consumption as well as adverse events. The User Configuration Database 408 stores information and metadata about the consumer's virtual power plant. In some cases, the User Configuration Database 408 may delegate storage and information requests to Virtualization Database 306 in the Virtual Resource Platform 132.

The Aggregation Server 130 also has access to third-party data 136 such as to billing management companies and carbon tracking companies. Access is via External Interface 134. In this way, the Aggregation Server 130 can apply analytics, not only to a consumer's virtual power plant, but all virtualized physical energy resources managed in the Virtual Resource Platform 132, and to third-party data of its choosing.

Analytics in the Aggregation Server 130 is performed by the Predictive Energy Manager 140. The Predictive Energy Manager 140 includes a Recommendation Engine 410 and various statistical algorithms 412, which can include Machine Learning and/or Generative Artificial Intelligence algorithms 414. Recall that the drivers 312 may not provide sufficient information for the statistical algorithms. For this eventuality, a software interpolator 416, performs gap filling to provide estimates for missing data in the statistical algorithms according to a predetermined statistical variation tolerance. Gap filling may involve use of historical averages of similarly situated devices and energy resource types, or vendor reported data, or extrapolations from other data.

The Predictive Energy Manager 140 may be invoked with a request by the Reporting Manager 144 which in turn is called via an API call 146. For any request, the Predictive Energy Manager 140 calls the Recommendation Engine 410 which stores the logic for various report types. Report types can be pre-configured (aka “canned” or pre-programmed), or can be free-form, such as a prompt for a GenAI algorithm. Regardless of report type, the Recommendation Engine 410 manages the logic and operational flow to create a response to the request.

Upon identifying the logic of the query, the Reporting Manager 144 retrieves the relevant Intelligent Energy Profile from the Profile Manager 138 through queries to the User Configuration Database 408 and the Historical Usage Database 406. Depending on the query, the Predictive Energy Manager 140 may also make queries to the Virtualization Database 306 and to external third-party data sources 136 via external interface 134. In some cases, third party data such as environmental and/or weather data, and market data, and/or energy cost data, and/or tariff data may be accessed via third party data sources 136. The Intelligent Energy Profile Manager 138 may call application programming interfaces in the external interface software module 134 so it will have well known APIs to access the third party data sources 136.

As directed by the Reporting Manager 144, the Predictive Energy Manager 140 will apply relevant analytics algorithms 412 and 414 to the retrieved data. Based on the query logic the Reporting Manager 144 will then format the results from the algorithms into a response to the query. The Reporting Manager 144 will return the finalized report via API 146 which in turn responds to the client software on mobile device 402 and/or web portal 404.

Note that all reports from the Reporting Manager 144 make use of the Predictive Energy Manager 140 which is able to ensure rigorous statistical methodology because the Virtual Resource Platform 132 implements a driver system that guarantees inputs into the Virtual Resource Platform 132 that are used by the statistical algorithms 412, ML/GenAI 414, or otherwise applies an interpolator 416 for gap filling. Accordingly, each report is generated with a confidence score. Where the confidence score does not meet a predetermined threshold, or where the statistical variance is above a predetermined threshold (i.e., where the predictive value of the report is below a predetermined utility), the Reporting Manager 144 can return a warning, an error, or simply not return a report. All too often, software applications generate predictions and statistics, but do not test for statistical significance and rigor. This can cause users to rely on reports that are inaccurate or worse are in error. This statistical check ensures this is not the case with the Aggregation Server 130 and its constituent software.

Reports from the Reporting Manager 144 include recommendations that a user may or may not opt to implement. However, in some cases, a user may wish to automate the acceptance and implementation of at least one recommendation. This is possible with IDERS which have control APIs to implement such recommendations. Where a user configures the Predictive Energy Manager 140, recommendations from the Recommendation Engine 410 can be received by an Execution Engine 418 in the form of a script. The Execution Engine 418 is a programmatic script interpreter that can programmatically access APIs of IDERS from their respective drivers 312. Note that the Execution Engine 418 is an interpreter, and is capable of receiving recommendations in the form of byte-code and p-code for interpretation. Accordingly, references to “scripts” herein include any interpretable computer executable code, not just human readable script code. Upon receiving a script from the Recommendation Engine 410, Execution Engine 418 performs the tasks in the script, and where an IDER is to be commanded, be it for configuration or operation or telemetry, the Execution Engine 418 may call the relevant API. In this way, the Predictive Energy Manager 140 can perform active orchestration, that is automated orchestration of IDERs.

It is worthwhile to describe particular use cases to illustrate the utility of Intelligent Energy Profiles and Predictive Energy Management. One set of reports is simply to provide overall reporting for a virtual power plant. For example, one may review historical usage data with rolled up data for an entire virtual power plant, rather than for individual IDERs. A report can then show holistic reports not just indicating your energy consumption but can also identify devices that use a disproportionate amount of energy (aka “energy hogs.”) Note further that because information is captured in near real time, the information is guaranteed to be timely. For example, if your energy utilization is about to exceed a predetermined threshold, you can lower energy utilization immediately to address the problem, rather than discover a problem after the fact.

Another set of reports may be to make use of third-party data. Consider the example of bill validation. Oftentimes, a utility will provide erroneous bills. The Report Manager 144 can combine outside utility and billing information 134 via External Interface 136 and compare it with actual telemetry. In this way not only can billing errors be detected, but also proof provided to establish the veracity of any challenge.

Third-party data can include service level agreements (SLAs) and warrantees. While IDER vendors typically provide warrantees, most consumers presently do not have the means to verify compliance. However, because the Aggregation Server 130 may access SLAs and vendor warrantees 136 via external interface 134, historical data can be compared to those SLAs and warrantees and non-compliance automatically detected. Accordingly, this provides the means for consumers to report issues to vendors along with proof. The alternative is to operate with defective equipment or improper installations without knowledge.

A very powerful set of reports involves the application of analytics by the Predictive Energy Manager 140 to provide recommendations. Because the Predictive Energy Manager 140 has access to information of all resources in the Virtualization Database 306 the Predictive Energy Manager 140 can surface options to consumers.

Options may include showing on a mobile device 402 or web portal 404 comparative data for switching energy providers and DNOs. The client application can show actual cost savings, breakdowns of cost savings, fees to switch, and savings over time to breakeven. The client application 402, 404 can even provide graphical representations of savings. For example, a school may wish to determine whether to change electricity utilities. The savings can be represented with a graphic of teacher icons representing the number or amount available for teacher salaries that would be recovered with a utility switch.

Options may include recommendations of whether to change a user's virtual power plant configuration. A common example would be to recommend adding batteries and potentially solar panels. Not only could savings and savings over time be reported, but also recommendations for local vendors along with expected costs and financing options.

Another example would be to change IDER vendors. Not only could a Predictive Energy Manager 140 provide information as to which batteries were failing, but also recommendations for makes and models for replacement and installers.

Options may include recommendations for changes in behavior. By way of example, many utilities charge tariffs for peak energy hours. This tariff information is accessible from utilities 136 via external interface 134. The Predictive Energy Manager 140 can then identify the impact of washing clothes after peak hours, or the impact of time shifting by installing solar panels and batteries.

The above options are merely exemplary and not intended to be limiting. But as shown above, Intelligent Energy Profiles and Predictive Energy Management provide consumers with information external to a single consumer's virtual power plant, information for options, and analytics with data supporting courses of action. The data can be used to report problems to vendors and utilities, or to inform optimizing courses of action. Regardless of how the data is used, the result is more efficient, more economical, and more timely management of energy.

### Operation of Predictive Energy Management

Having described the Predictive Energy Manager 140 and its components, we are not ready to discuss its operation. FIG. 5 is a flow chart 500 describing how the Predictive Energy Manager 140 collects data, creates an Intelligent Energy Profile, creates predictions, and generates recommendations.

We start with the notion of a collection of IDERs. Each IDER has a driver 312 provided by and managed by the Virtual Resource Manager 132 as described with respect to FIG. 3. These drivers provide the means to collect configuration metadata on how its respective IDER is configured, its respective energy utilization (here utilization including both energy consumption and production) history, and programmatic control for the IDER. Additionally, third party data, such as environmental/weather data, and energy cost/market/tariff data may be accessed and included for analysis. The most common collection of IDERs is for a building or a portion of a building. For each collection of IDERs a summary of its configuration and its energy utilization, called an Intelligent Energy Profile can be generated by an Intelligent Energy Profile Manager 138. An Intelligent Energy Profile not only summarizes data for the collection of IDERs it does so such that the data contained may be used to perform statistical operations to predict future states and to recommend optimizations.

Collections of IDERs in which each collection has its own Intelligent Energy Profile enables the ability to scale. A portion of a building, such as an apartment, may have a collection of IDERs with its own Intelligent Energy Profile. The apartment's collection may be itself be a subcollection aggregated by another collection of IDERs for the entire apartment building. A campus of buildings, each with their own respective collection of IDERs and their own respective Intelligent Energy Profile may be subcollections for a microgrid with its own Intelligent Energy Profile. Such scaling, such as multiple microgrids may continue up to the entire national grid.

In block 502 the user configuration database 408 collects metadata about individual IDERs. IDER metadata settings may include make and model, but also user settings, and operating parameters. Because each IDER is accessed via its own driver 312, and because the driver 312 has standardized APIs the user configuration database 408 knows which APIs with which to retrieve any desired metadata.

In block 504 the historical usage database 406 collects energy utilization data for each IDER. Here utilization may mean production or alternatively consumption. Note that some IDERs are both producers and consumers of electricity. As with IDER metadata, because each IDER is accessed via its own driver 312, and because the driver 312 has standardized APIs the user configuration database 408 knows which APIs with which to retrieve any desired historical usage data. Note that in some cases, there may be gaps in data. Accordingly, a software interpolator 416 may be used for gap filling as described with respect to FIG. 4. Specifically, similar devices with available data may be aggregated and estimates made as to what the missing data is most likely to have been. For example, the software interpolator 416 based on the make and model of the IDER finds IDERs with similar operating parameters. The software interpolator 416 may apply the inputs of the IDER with the missing data to the similar IDERs and generate estimates used to gap fill the missing data.

As stated above, the Intelligent Energy Profile can include accessing utility DNO/DSO information as well as contextual information such as environmental/weather data and market/energy cost/tariff data. This data is generally accessed via third party data sources 136. The Intelligent Energy Profile Manager 138 may call application programming interfaces in the external interface software module 134 so it will have well known APIs to access the third party data sources 136.

In block 506, an intelligent energy manager software module accesses for a collection of IDERs configuration metadata from the user configuration database 408, and historical usage data from the historical usage database 406. This data is converted to a summary format organized into rows and columns. Each row has consistent fields, and each row represents a measurement. The rows and columns in this way provide a dataset. This dataset can in turn be used to train an AI, provide retrieval augmented generation (RAG) data for a GenAI, or simply be used for non-AI statistical analysis. Regardless of the method used, the dataset comprising the intelligent energy profile provides a statistically significant amount of data to enable predictions and recommendations, e.g., data having a variance from a standard deviation that exceeds a predetermined threshold.

In block 508, either a non-AI statistical algorithm is selected from a set of predetermined statistical algorithms 412, or a machine learning or GenAI algorithm is used 414, to make a prediction of a future state of the collection of IDERs. A future state can include whether a condition such as a weather change will occur, triggering a spike of energy utilization (e.g., high outside heat causes the need for energy for air conditioning, or a snowstorm in which there is a need for a driveway defroster). In general, predictions will focus on whether there is a need for energy or whether there is excess energy for returning for net metering.

In the case of GenAI, a GenAI application comprising a language model, such as a large language model, and a reinforcement learning neural net may be used. The GenAI application receives a prompt, the prompt may be modified using preloaded data in a retrieval augmentation generation buffer. The prompt may make a request for at least one prediction based on one or more predictive algorithms. Because the GenAI application can generate multiple predictions, those predictions may be amalgamated into a single prediction.

Once a prediction is made concerning the future state of the collection of IDERs, block 510 is concerned with generating a recommendation with a recommendation engine software module 410. A recommendation is where an improvement over the future state of the collection of IDERs can be specified. To clarify what is meant by improvement, a predetermined object function, such as minimizing energy utilization, minimizing carbon emissions, or minimizing energy cost can be selected. Where the predetermined object function shows that application of an optimization will provide a more optimal future states of the collection of IDERs (i.e., less energy used), that recommendation can be returned.

Different users will have different levels of confidence in the recommendations returned by the recommendation engine 410. Some will wish to automate the implementation of the recommendations while others may wish to review the recommendations prior to any implementation.

The Predictive Energy Manager 140 can be configured for automatic execution of recommendations from recommendation engine 410. In this way the Predictive Energy Manager 140 may provide active orchestration—that is a fully automated feedback loop to dynamically reconfigured IDERs and collection of IDERs for optimization. Note that the recommendation engine 410 can generate optimizations in any textual format including computer executable scripts. In block 512, if the recommendation is in computer executable script form, it is forwarded to Execution Engine 418. Execution Engine 418 is a script interpreter (e.g., javascript interpreter, python interpreter), which automates the recommended optimization. Note that optimizations most likely will include reading IDERs and commanding IDERs. This is accomplished via the scripts and Execution Engine 418 invoking APIs in the IDER drivers 312 managed by the Virtual Resource Manager 132.

Alternatively, in block 514, the recommendation is not a computer script to be executed. In this case, a Reporting Manager software module 144 is used to create a formatted human readable output (known as “pretty printing”) and is returned to the user for evaluation.

### Energy Accounting System

One deficiency in present energy management systems is that they report financial information, such as potential savings, but do not make use of public accounting standards. While for residential and unsophisticated consumers, such ad hoc reporting of financial data may be sufficient. However, when managing large amounts of data across multiple users, for example for commercial, industrial, and governmental/public applications, this is not sufficient. In the case of the Aggregation Server 130, because it has visibility across multiple consumers and virtual power plants, the Aggregation Server 130 associates energy resources and their associated costs with those multiple consumers and virtual power plants. This gives rise to the application of accounting methods which excel at attributing costs as to make proper inferences from financial data.

To this end, an Energy Accounting System 142 is disclosed. Specifically, the Energy Accounting System 142 supports national and globally accepted accounting standards such as Generally Accepted Accounting Principles (GAAP) and Financial Reporting Standards (FRS). This allows for unified and native accounting operations such as activity-based cost accounting and managerial and financial accounting for energy transactions. Combined with an exchange mechanism, the energy management system via an Aggregation Server 130 would provide a platform to perform energy transactions.

FIG. 6 provides a diagram 600 for the Energy Accounting System 142 and its context.

The Energy Accounting System 142 provides a General Ledger 602 and a Chart of Accounts 604 to organize entities to attribute credits and debits. The General Ledger 602 and Chart of Accounts 604 may be implemented as database tables and records. In one embodiment, a Chart of Accounts 604 may be a table in a relational database where each child account references the index of its parent account, and the General Ledger 602 are detail records of credits and debits indexed to the relevant Chart of Accounts 604 account. In other embodiments a cross-reference table stores the relationship of the child and parents accounts in the Chart of Accounts 604.

Accordingly, the Energy Accounting System 142 interfaces with the Intelligent Energy Profile Manager 138 to provide classification information to attribute energy credits and debits; with the Predictive Energy Manager 140 and Reporting Manager 144 to respond to queries for reports, and with the APIs and Administrative Module 146 for maintaining the General Ledger 602 and Chart of Accounts 604.

Note that terminology may be different between customers, vendors, and other entities. Accordingly, an Ontology Engine 606 implemented as a terminology database, stores different terminology and resolves that terminology to a standard term recognized by the General Ledger 602 and Chart of Accounts 604. Specifically, when the Energy Accounting System 142 receives an unknown term, it can query the Ontology Engine 606, identify whether the term is recognized or not, and if recognized, retrieve the standard term associated with the incoming term. If a term is not recognized, an administrator can determine whether to update the Ontology Engine 606.

The Energy Accounting System 142 receives representations of the provenance of energy from outside sources. Furthermore, as energy from different sources are mixed and matched through the reaggregation and virtualization processes set forth with respect to FIG. 3 above, characterizing whether energy meets certain requirements, such as whether the energy comes from green or brown sources, becomes obscured. To protect the integrity of the Energy Accounting System 142, and otherwise to ensure that outside data is trustworthy and will not corrupt internal data, the Energy Accounting System 142 implements a software cryptographic capable Certification Manager 608. Specifically, when energy enters the Aggregation Server 130, either from the outside power grid 136, from DNOs 136, or internally generated by IDERs managed by the Virtual Resource Platform 132, the Certification Manager 608 creates a cryptographic certificate for that energy representing the quantity and provenance of the energy and any metadata to characterize the energy. An example of a characterization would be whether the energy is green energy, brown energy, or otherwise.

The generated certificate can then be associated with records on a software Audit Log 610 implemented on a database. The Audit Log 610 store metadata and information about the provenance, quantity, and characterization of the associated energy that will not fit on a certificate, or otherwise should be easy to access via a database interface. The Audit Log 610 also stores the customer consuming the energy and how the remaining energy is reaggregated. As energy is reaggregated, new certificates can be generated that are associated with the relevant portion of aggregated energy. In this way, a chain of custody of the provenance of each portion of reaggregated energy can not only be tracked but also tracked in a trusted fashion.

The Energy Accounting System 142 equipped with a Certification Manager 608 and Audit Log 610 gives rise to various exemplary use cases.

One example is the notion of a Carbon Net Zero system. For a particular installation, some subsets of customers can be collected into what is characterized by Carbon Net Zero, that is to say that the consumption of energy is attributed to green sources or from green carbon credits. Because the Energy Accounting System 142 issues certificates via the Certification Manager 608 attesting to source and whether the source is green or not, the Aggregation Server 130 can determine whether consumption matches incoming green sources. If it does not, the Aggregation Server 130 may be configured to interface with third-party carbon exchanges to purchase offsets or otherwise get to Net Zero. Because the Energy Accounting System 142 is fine-grained, that is it continues to track green status across virtualization and reaggregation, there is no loss of energy attributed to green sources.

In general, Carbon Net Zero and carbon economy participation is possible because of the rigors imposed by an Energy Accounting System 142. Consider for example Sustainable Development Goal (SDG) reporting which has its own requirements for compliance. Such compliance is only possible with rigorous provenance checking.

Another example is the notion of tokenizing energy generation and other related activities. Because the Certificate Manager 608 generates cryptographic certificates for all incoming energy, including generated energy, those certificates may in turn be tokenized, that is converted into exchangeable cryptographic artifacts that may be traded. In some embodiments the tokens may underlie a cryptographic currency. In other embodiments the tokens may be traded in of themselves. Users of such tokens need only have user records created in the Intelligent Energy Profile Manager 138, and the tokens associated with the relevant profiles. The Audit Log 610 tracks utilization. When the energy underlying the token is consumed, the record of the token is either destroyed or deactivated.

The aforementioned examples are not intended to be limiting. Rather the examples are illustrative of some emergent properties. Because energy transactions are tracked according to Generally Accepted Accounting Principles or equivalent accounting regimes, reporting across multiple consumers and entities is possible in a disciplined fashion. For example, credits and debits of energy can be tracked via double entry bookkeeping. Furthermore, enterprises with accounting compliance requirements need not translate ad hoc reports into GAAP or equivalent compliant reporting.

Beyond reporting, because the Energy Accounting System 142 provides cryptographic grade certifications to track provenance, interfacing with the carbon economy, or cryptographic currency economy, or any other economy is enabled. In short, the Energy Account System 142 provides compliant and fine-grained reporting for energy input including generation and consumption.

### Predictive Energy Management, Privacy, and Cybersecurity

Predictive Energy Management relies on data to be able to perform the statistics that underly predictions and recommendations. However, users rightfully may request data associated with their accounts deleted. This, of course, can compromise having the information basis for perform the statistics that underly predictions and recommendations. Upon deletion, the predictive capabilities of the Aggregation Server 130 should fail gracefully, i.e., allowances for less accurate predictions should be made by the software infrastructure until the variances are no longer acceptable.

Turning back to FIG. 1, the Aggregation Server 130 includes a software Security Engine 148 that handles encryption, and tracks when data is deleted. The Reporting Manager 144 and the Predictive Energy Manager 140 are communicatively coupled with the Security Engine 148.

Specifically, the Security Engine 148 performs cryptographic key generation and key management for user accounts and manages encryption at rest for user profile data and user personal data if applicable. When a user requests deletion of data, the Security Engine 148 stores a database log as to what data is removed, in particular from the Historical Usage Database 406 and the User Configuration Database 408. As stated above, the software Security Engine 148 interfaces with the Intelligent Energy Profile Manager 138 and the Predictive Energy Manager 140 to do so.

Accordingly, if the Reporting Manager 144 or the Predictive Energy Manager 140 receive a request from a user, the Reporting Manager 144 or the Predictive Energy Manager 140 may query the Security Engine 148 to determine whether data has been deleted. If some or all data has been deleted, the Reporting Manager 144 or the Predictive Engine may invoke the software interpolator 416 to gap fill as described in FIG. 4 above. If the interpolator 416 cannot gap fill within a predetermined threshold of variance, that is to say that the gap filling will result in a statistical error to obviate reliability and the benefit of prediction, then an error is returned. In this case, a client application may decide to hide or otherwise disable the predictive feature.

The “right to be forgotten” that is the right for a consumer to have personal data and data attributable to the user to be delete in demand is codified in various laws, most notably the General Data Protection Regulation (GDPR) in the European Union. Versions of this right apply through analogous law in other jurisdictions such as the United Kingdom and various states in the United States. All too often, software application developers know that predictive capabilities, through machine learning, GenAI, or traditional statistical algorithms are compromised from data deletion, but fail to address this risk. The aforementioned system and techniques describe and approach that checks for predictive accuracy with graceful failover as users exercise their rights to be forgotten.

### Business Use Cases for Predictive Energy Management

Energy Orchestration and Predictive Energy Management implemented by the Aggregation Server 130 enable many business use cases. In particular Three specific use cases are described below without limitation.

A first use case is around the Aggregation Server 130 providing a monetization platform to enable users to be fully informed in switching energy providers. While the Aggregation Server 130 provides comparative information about energy providers and DNOs, an obstacle is in encouraging users to install an application on their mobile device 402 that accesses the Aggregation Server 130 in the first place.

In one embodiment, a mobile application is provided in a freemium and in a paid premium application. The freemium application provides enough information as to whether a user should switch energy providers. Specifically, the application indicates historical usage, historical costs, and alternative providers. Data for historical usage and historical costs is obtained from the Historical Usage Database 406. Information from the alternative providers may be obtained through External Interface 134.

The application can provide not just costs of alternative providers and related issues, but also automate the switch. Specifically, the application can make a request to the Aggregation Server 130 to run a server-side application executed on the Script Execution Engine 150. The server-side application interfaces with different energy providers via External Interface 134 to effect an automated switch.

Since the application provides the instant gratification of immediate savings through switching energy providers, users are motivated to install the freemium application. Costs for promoting the freemium application may be underwritten through contracts with energy providers that pay a commission or bounty for motivating users switching to their services. Because the server-side application performs the actual switch, the server-side application can provide auditable proof that the customer switching should be attributable to the application and therefore should be paid commission.

Now with the application installed, the user may then discover other ways to save. The freemium application may then surface historical savings of other similarly situated users as an incentive for a user to switch to the paid for premium application. Upon subscription, the premium application will then provide both long term and real time recommendations for changes of vendors, configuration, behavior and the like as described with respect to FIG. 4 above. The set of users that convert to the paid for premium application constitutes the basis for a commercial going concern.

Another business scenario relates to providing a web portal for public institutions such as grade schools. Because the Aggregation Server 130 does not require users to be geographically proximate, and because virtualization enables the arbitrary aggregation of users, a set of grade schools, even ones geographically disparate can be aggregated together. Those grade schools, thus aggregated, can then shift energy from one school to another. Furthermore, the grade schools can receive recommendations with respect to energy provider, vendor, configuration, and behavior to minimize costs. In this way, a paid subscription service for access to the Aggregation Server 130 can be financially justified.

An emergent property of aggregating disparate schools together is the ability of those schools to collectively negotiate a bulk rate for energy that would otherwise not be possible by a single school. Because the Aggregation Server 130 maintains an Energy Accounting System 142, attribution of energy sources and energy consumption is reliably tracked.

Another emergent property of aggregating disparate schools together is collective participation in the carbon economy. Because the aggregated schools may report carbon emissions, compliance with carbon emissions can be load balanced by exchanging energy between schools and ultimately, if necessary, collectively negotiating carbon credits and offsets.

As a final note, it is observed that schools often are located based on population density. Versions of the freemium and premium business model described above can be simultaneously marketed to parents of students at the schools.

The business models described above are just two possible business models enabled by Energy Orchestration and Predictive Energy Management as implemented by the Aggregation Server 130. These examples are not intended to be limiting but rather to illustrate broad applicability.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method to perform predictive energy management, comprising each of the following as executed on at least one computer device:
accessing configuration metadata from a collection of one or more intelligent distributed energy resources (IDERs);
receiving, over a communication network, telemetry data from at least some of the collection of IDERs, the received telemetry data representing historical utilization of energy data for a corresponding IDER in the collection; and
creating an intelligent energy profile based on the collection of IDERs, the intelligent energy profile comprising a summary of the received configuration metadata and historical utilization of energy data of the at least some of the collection of IDERs, and wherein the intelligent energy profile further comprises a set of statistically significant information;
executing a predictive algorithm based on the generated intelligent energy profile to create at least one predicted future state of the collection of IDERs; and
based on the at least one predicted future state, generating at least one recommendation, the recommendation comprising at least one optimization technique to create a desired improvement of the collection of IDERs; and
presenting the at least one recommendation for presentation for execution.

2. The method of claim 1:
wherein the telemetry data is received over the communication network via an application programming interface (API) made available by a computer-implemented virtual resource manager; and
wherein the at least one recommendation for presentation for automatic execution.

3. The method of claim 1:
wherein the received telemetry data includes telemetry data from at least one IDER of the collection of IDERs, and
wherein the method further comprises generating interpolation data via a software interpolation software module to add interpolated data to the historical utilization of energy data where there are gaps in the historical utilization of energy data.

4. The method of claim 3 further comprising generating interpolation data via a software interpolation software module to add interpolated data to the historical utilization of energy data where there are gaps in the historical utilization of energy data.

5. The method of claim 1, wherein the predictive algorithm was selected from a set of a plurality statistical algorithms.

6. The method of claim 1, wherein the predictive algorithm is implemented via a trained generative artificial intelligence application, the trained generative artificial intelligence application having been trained by repeated prompting of a language model combined with a reinforcement learning model.

7. The method of claim 4:
wherein the at least one recommendation comprises a computer executable script;
wherein the computer executable script is configured to access an API of an IDER of the collection of IDERs, and further configured to call the API via a driver managed by a virtual resource manager; and
wherein the method further comprises executing the computer executable script.

8. The method of claim 1, further comprising:
receiving the generated recommendation; and
generating a human readable report.

9. The method of claim 1, wherein at least two of the collection of IDERs are geographically disparate as not to be in a same building.

10. The method of claim 1, wherein the collection of IDERs is a microgrid comprised of IDERS distributed among multiple buildings, and wherein each building of the multiple buildings having a having its own respective intelligent energy profile.

11. The method of claim 1, wherein the collection of IDERS is a collection of microgrids on a common national power grid, each microgrid having its own respective intelligent energy profile, each microgrid comprised of IDERs distributed among multiple buildings, each building having its own respective intelligent energy profile.

12. A system to perform predictive energy management, comprising:
a user configuration database configured to store configuration metadata for a plurality of intelligent distributed energy resources (IDERs) of a collection of IDERS;
a historical user database configured to store historical utilization of energy data by at least some of the IDERs in the collection of IDERS;
an intelligent energy profile manager software module configured to access the user configuration database and the historical user database to generate an intelligent energy profile corresponding to the collection of IDERs, the intelligent energy profile comprising a summary of the received configuration metadata and the historical utilization of energy data, wherein the generated intelligent energy profile comprises a set of statistically significant information for predicting future energy utilization for the collection of IDERs.

13. The system of claim 12, wherein the collection of IDERs is comprised of at least one subcollection of IDERs, the subcollection of IDERs comprising a plurality of IDERs and having its own respective intelligent energy profile.

14. The system of claim 12, further comprising a software interpolation software module configured to use mathematical methods to add interpolated data for usage gaps in the historical utilization of energy data.

15. The system of claim 14, further comprising:
a predictive algorithm configured to read a generated intelligent energy profile of a collection of IDERs, and based on the intelligent energy profile, predict at least one potential future state of the collection of IDERS; and
a recommendation engine software module configured to generate at least one recommendation comprising at least one optimization technique contributing to an improvement over at least one potential future state of the collection of IDERs.

16. The system of claim 15, further comprising a generative artificial intelligence software application comprising a language model in combination with a reinforcement learning model, the generative artificial intelligence software application configurate to receive a prompt to select one or more predictive algorithms, generate a prediction of at least one potential future state of a collection of IDERs based on the selected predicted algorithm, and select one or more optimization algorithms to improve the future state of the collection of IDERs.

17. The system of claim 16, further comprising a reporting manager software module configured to receive a recommendation and from the received recommendation generate a human readable report.

18. The system of claim 16, further comprising an execution engine software module configured to receive a recommendation formatted into a computer executable script, and to execute the received recommendation.

19. The system of claim 18, further comprising a virtual resource manager software module configured to manage drivers for IDERs wherein each driver exposes an application programming interface to provide configuration metadata, historical utilization of energy data, and programmatic control of each respective IDER.

20. One or more computer-readable storage media collectively having thereon computer-executable instructions that, when executed, collectively cause one or more computers to, at least:
receive configuration metadata from a collection of one or more intelligent distributed energy resources (IDERs) and store the received configuration metadata in a user configuration database;
receive telemetry from the collection of IDERs representing historical utilization of energy for each IDER in the collection and store the received telemetry in a historical user database;
create an intelligent energy profile manager software module an intelligent energy profile of the collection of IDERs comprising a summary of the received configuration metadata and historical utilization, wherein the intelligent energy profile contains a set of statistically significant information sufficient to predict future energy utilization for that collection of IDERS;
predict via a predictive algorithm against the generated intelligent energy profile, at least one potential future state of the collection of IDERS;
generate at least one recommendation via a recommendation engine the recommendation comprising at least one optimization technique contributing to an improvement over at least one potential future state, the generated at least one recommendation in a format of a computer executable script;
receive at an execution engine software module configured to execute computer executable script, the at least one recommendation in the format of a computer executable script;
execute at the execution engine the received computer executable script; and
where the computer executable script directs the access of an application programming interface for an IDER, call the application programming interface via a driver managed by a virtual resource manager.
